(19) United States
(12) Patent Application Publication
(10) Pub. No.: US 2005/0289014 A1
(43) Pub. Date: Dec. 29, 2005

(54) Method and system for processing event-triggered transactions

(76) Inventor: James M. Butler, Saratoga, CA (US)

Correspondence Address: James M. Butler, 14737 Live Oak Lane, Saratoga, CA, 95070, US

(21) Appl. No.: 11/156,649

(22) Filed: Jun. 21, 2005

Related U.S. Application Data
(60) Provisional application No. 60/582,179, filed on Jun. 23, 2004.
(60) Provisional application No. 60/582,212, filed on Jun. 23, 2004.

(51) Int. Cl. G06F 17/60

(52) U.S. Cl. 705/26

(57) ABSTRACT

The invention relates to a system and method for processing transactions triggered by real estate-related events. In particular, the method may include storing customer profiles in a database. The customer profile may include customer identification information and at least one or more customer-requested real estate-related services and products that are to be automatically ordered upon the occurrence of specific events. Data from multiple information sources may be monitored and compared with the customer identification information from the customer database such that if the monitored data matches the customer identification information, the one or more real estate services and products specified in the profile of the identified customer may be automatically ordered.

### CROSS REFERENCE TO RELATED APPLICATIONS

This non-provisional patent application claims benefit of U.S. Provisional Application No. 60/582,179, filed Jun. 23, 2004, entitled “Automatic Order System” and U.S. Provisional Application No. 60/582,212, filed Jun. 23, 2004, entitled “Multiple Website Data Aggregation System.”

### FIELD OF THE INVENTION

This invention relates generally to the field of automatic transaction processing, and more specifically to a process for processing service/product customer orders automatically.

### BACKGROUND OF THE INVENTION

Business transactions involving products, property and/or services often require many components, such as data and documents, and related services or parts. Often the ordering, scheduling and coordination of these products and services become very complex and time consuming.

For example, in real estate, as part of selling a home, sellers most often hire a realtor to act on their behalf. The realtor's responsibilities include marketing/advertising, negotiating contracts, providing the seller with all of the legally required disclosures, and hiring outside experts to provide services such inspections, and reports. Since the realtor usually acts as the decision maker in hiring outside service providers, these vendors target the realtor with passive methods of advertising and marketing to gain customers.

Currently, the only way vendors proactively make a sale is to contact a realtor directly and hope their timing is “on” and that the realtor is in need of their product/service. The other way vendors achieve sales is through passive sales techniques by waiting for the realtor/customer to contact them when the customer has a need for their product/service. In order for realtors to contact the vendor to use their product/service, the realtor has to be aware of the vendor's presence in the market. The primary methods used to raise realtors' awareness are print advertising, attendance at real estate industry trade events such as trade shows and conventions, attendance at local meetings such as real estate office meetings and localized marketing meetings.

The primary disadvantages of the current system include:
1) A repetitive vendor sales cycle processes;
2) Vendors rely on a passive sales approach which has no guarantee of producing any sales;
3) Any proactive sales approach is a sporadic style where the vendor puts out as much literature and networking as possible and then hopes to get a sale;
4) Vendors have no way of ensuring future sales,
5) Vendors cannot lock out their competition, and
6) Vendors cannot proactively retain their customer base.

### SUMMARY OF THE INVENTION

The invention relates to a system and method for processing transactions triggered by real estate-related events. In particular, the method may include storing customer profiles in a database. The customer profile may include customer identification information and at least one or more customer-requested real estate-related services and products that are to be automatically ordered upon the occurrence of specific events. Data from multiple information sources may be monitored and compared with the customer identification information from the customer database such that if the monitored data matches the customer identification information, the one or more real estate services and products specified in the profile of the identified customer may be automatically ordered.

This method may also be applied to the processing of other event-triggered transactions. In particular, the method may include storing customer profiles in a database. The customer profile may include customer identification information and at least one or more customer-requested services and products that are to be automatically ordered upon the occurrence of specific events. Data from multiple information sources may be monitored and compared with the customer identification information from the customer database such that if the monitored data matches the customer identification information, the one or more services and products specified in the profile of the identified customer may be automatically ordered.

### BRIEF DESCRIPTION OF THE DRAWINGS

The drawings constitute a part of this specification and include exemplary embodiments to the invention, which may be embodied in various forms.

FIG. 1 is a flowchart that depicts the “Spray and Pray” technique of marketing and sales.

FIGS. 2A-B are flowcharts depicting the realtor listing cycle that a realtor performs.

FIG. 3 is a block diagram illustrating a multiple website data aggregation system.

FIG. 4 is a flowchart one illustrating one embodiment of an overview of the automatic order process.

FIGS. 5A-G are a flowchart that depicts the Automatic Order System process.

FIG. 6 is a screenshot of the main user interface in the customer relationship management system.

FIG. 7 is a screenshot of the Initial Calls screen, which contains a list of potential customers that may sign up for the Automatic Order System.

FIG. 8 is a screenshot of the Call Again field that appears on the Initial Calls screen when the Call Again radio button is pressed.

FIG. 9 is a screenshot of the Customer Information screen, which contains a button to reach the realtor Office Maintenance screen.

FIG. 10 is a screenshot of the Customer tab in the realtor Office Maintenance screen, which is used to maintain information about Automatic Order System customers.

FIG. 11 is a screenshot of the Real Estate Office tab in the realtor Office Maintenance screen, which is used to maintain information about the real estate companies that the vendor works with.

FIG. 12 is a screen shot of the Title Companies/Officer button in the realtor Office Maintenance screen which is pressed to navigate to the Title Company Maintenance screen.

FIG. 13 is a screen shot of the Title Officer tab in the Title Company Maintenance screen which is used to add, modify, and delete Title Officers in the system.

FIG. 14 is a screen shot of the Title Company tab in the Title Company Maintenance screen which is used to add, modify, or delete Title Company information.

FIG. 15 is a screen shot of a Title Officer screen pop up message that occurs when a Title Company name is added to a new Title Officer's record.

FIG. 16 is a screen shot of the Title Officer's tab within the Customer tab of the realtor Office Maintenance screen.

FIG. 17A-B is a flowchart that depicts the variety of ways that real estate data can be extracted by a vendor and then utilized to sign up a realtor for the automatic order service. This process occurs during the realtor's listing cycle.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure, or manner.

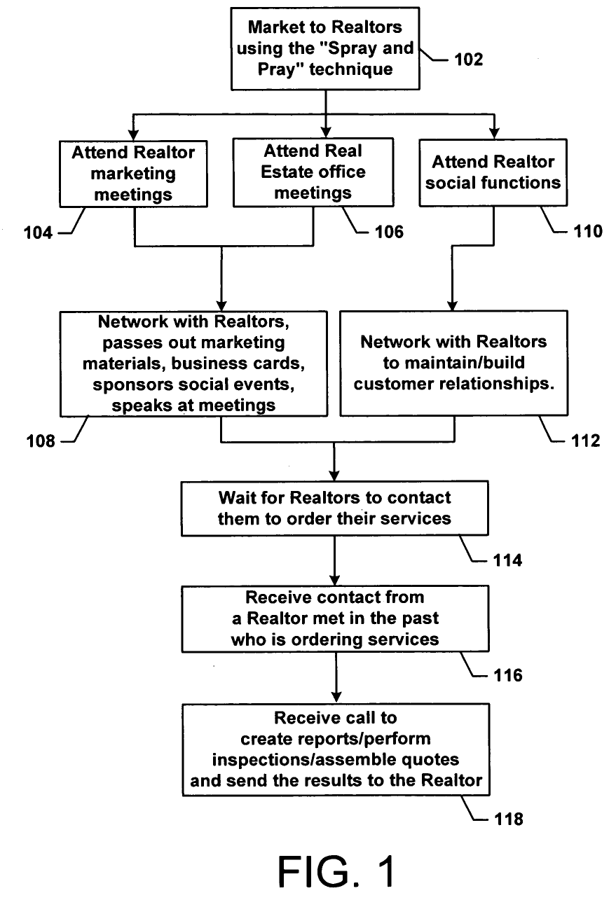

FIG. 1 is a flowchart that represents a prior art vendor Marketing Cycle. This is the cycle that vendors currently utilize to market and sell to their target customers. This cycle is referred to as using the “Spray and Pray” technique of marketing and sales. Steps 102 through 112 show how the vendor “Sprays” its name out to the target market. This is a term that refers to the advertising and marketing that vendors perform to provide awareness of their product/service to their customers.

Steps 114 through 118 illustrate the “Pray” portion of this cycle, whereby the vendor has finishing spraying its name to the target market, and is now forced to wait passively in the hopes (praying) that the customer will have seen and remember the vendor's name and will contact the vendor to purchase its product/service.

The diagram begins in Step 102, where the vendor markets to realtors using the “Spray and Pray” technique. Steps 104 through 108 demonstrate the various ways that this technique is performed. In Step 104, the vendor attends realtor marketing meetings to distribute information on their services. In Step 106, the vendor attends real estate office meetings. At these two locations, the vendor networks with realtors and passes out marketing materials, business cards, sponsors social events, and speaks at meetings. This is shown in Step 108. In Step 110, the vendor attends realtor social functions. In Step 112, the vendor networks at these social functions with realtors to maintain and build customer relationships. Step 114 begins the “Pray” portion of the vendor marketing cycle. In Step 116, the vendor passively waits for realtors to contact them to place an order. In Step 116, the realtor contacts a vendor that they have met in the past to order their services. In Step 118, the vendor receives a call from the realtor to create reports, perform inspections, and/or assemble quotes and sends the results to the realtor.

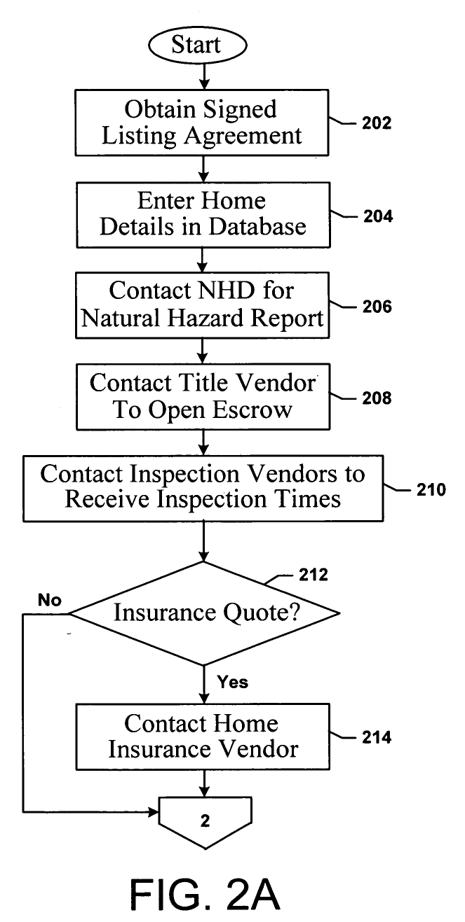

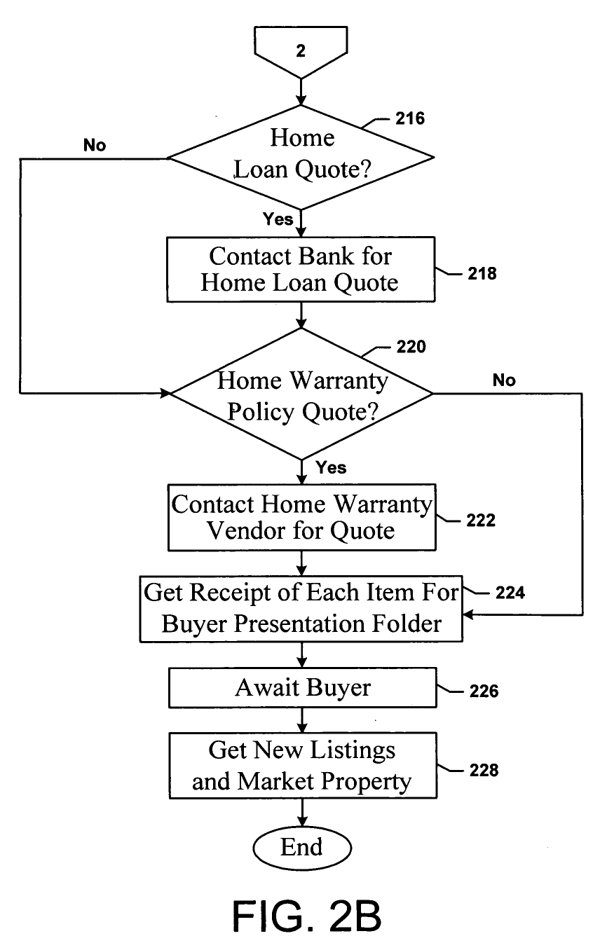

FIGS. 2A-2B illustrate in a flowchart the old technology from the customer's (realtor) perspective. This diagram illustrates the process the realtor must go through (the Listing Cycle) each and every time the realtor places a home up for sale on behalf of a homeowner. This is a cycle of constant, time consuming, repetition where performing steps 206-222 represents the vast majority (60%-70%) of the realtor's time.

The realtor Listing Cycle begins in Step 202, where the realtor obtains a signed Listing Agreement from the seller. In Step 204, the realtor puts the details of the property into a database with information such as: realtor address, fax, phone, property address, and property details. Upon putting the property into a database, the realtor will need to contact various vendors to obtain products/services that are needed in order to sell the property. In Step 206, the realtor contacts a Natural Hazard Disclosure vendor either by phone, fax or web interface. The realtor then provides their name, phone number, mailing address, real estate company name, property address, name of the title company, escrow number, type(s) of report needed, and delivery preferences for the report(s). The Natural Hazard report is then sent to the realtor, and Step 103 is performed to open escrow. In Step 208, the realtor contacts the Title vendor via phone, fax, or web interface and provides them with their name, phone number, mailing address, real estate office name, and the address of the property for sale. Escrow is opened and the realtor receives the name of the title officer and the escrow number. In Step 210, the realtor contacts inspection vendors via phone, fax, or web interface and provides them with their name, phone number, mailing address, real estate company's name, and address of the property for sale. They must also provide the name of the title company along with their fax number and address, name of the title officer, escrow number, and size of the home. As a result, the realtor will receive appointment times for the home/pest/chimney/pool/foundation/well/septic system/roof inspections. Step 212 determines if the realtor wants to provide a homeowners insurance quote for the property. If the realtor does not want to provide this, the diagram skips to Step 216. If they do, the diagram continues to Step 214. In Step 214, the realtor contacts the home insurance vendor via phone, fax, or web interface and provides them with their name, phone number, mailing address, real estate company name, property address, type of insurance needed, age of the home, roof material, and delivery preferences for the quote. The realtor will then receive a hardcopy of the home insurance quote. In Step 216, the realtor decides whether or not to provide a home loan quote for potential buyers. If they would not like to provide this, the diagram skips to Step 220. If they would, the diagram continues to Step 218. In this step, the realtor contacts the bank via phone, fax or web interface and provides them with their name, phone number, mailing address, name of the real estate company, property address, type of loan (fixed or variable), and their delivery preferences for the quote. The realtor then receives the quote for the home loan from the bank. Next, Step 220 determines if the realtor would like to obtain a quote for a home warranty policy on the home they are selling. If they do not, the diagram skips to Step 224. If they would like to obtain a quote on a home warranty policy, the diagram continues to Step 222. In this step, the realtor contacts a home warranty vendor via phone, fax, or web interface and provides them with their name, phone number, mailing address, real estate company name, and the property address. They also must provide the name of the title company along with their fax number and address, the title officer's name, the escrow number, the type of warranty, and the size of the home. The realtor then receives a hardcopy quote for the home warranty from the vendor.

After all of the vendors have been contacted, Step 224 is performed. In this step, the realtor obtains copies of each of the items that they have ordered and places them in a buyer presentation folder. Meanwhile, the property sits on market awaiting a buyer in Step 226. In Step 228, the realtor continues to obtain new property listings and markets the property while all paperwork is complete. The cycle repeats itself and begins again in Step 202.

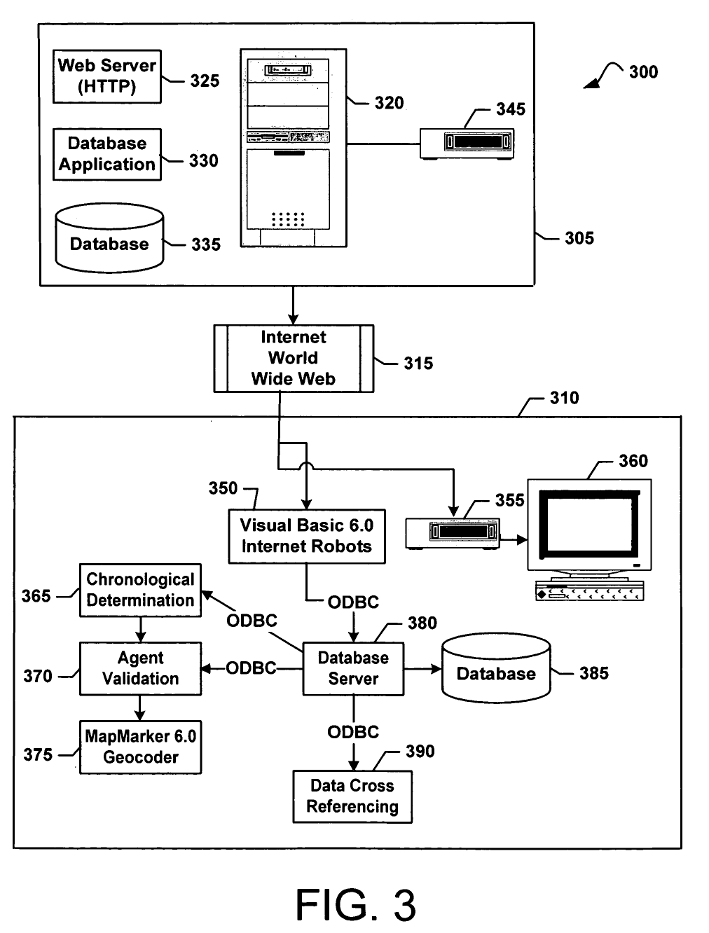

Referring to FIG. 3, a Multiple Website Data Aggregation System 300 is shown. The system includes a website 305, which is coupled to a network 315, and in turn to a Data Enrichment and Agent Identification System 310.

The website 305 typically uses a company server 320 such as a Windows-based, Linux, or Unix server. The website 305 has a modem 345 (or other form of internet connectivity such a T-1, ISDN, DSL, or cable modem). The server 320 typically contains a web server 325 that supports a Hypertext Transfer Protocol (HTTP) and handles requests for records, documents, and other services and then transmits such information over the network 315. The network 315 is for example the Internet. Many suitable software programs for web servers 325 include Netscape, Apache, Microsoft IIS, and O'Reilly. The web server 325 contains a database application 330 to connect and access information from a database 335 using the Open Database Connectivity (ODBC) protocol. ODBC is well known in the art and therefore will not be further discussed. Database applications can be created by using such scripting languages as ASP, CGI/Perl, Cold Fusion, JSP, and others.

The Data Enrichment and Agent Identification System 310 consists of an Internet robot 350 that is created by robot software, preferably in Visual Basic 1.0. The Internet robot 350 connects to the Internet 315 via a modem 355 (or other form of connectivity). Then, the Internet robot 350 sends search parameters to the website 305 via the Internet 315, which returns data to the Internet robot 350. The Internet robot 350 then connects to the database server 380 via ODBC and sends data to the database 385 where it is stored. The database server 380 is generally configured as an SQL database using products such as those from Oracle, Informix, Microsoft, or Sybase. Database 385 is a typical storage medium and is well known; more specifically the database 385 is a conventional relational database.

The user terminal, running customer relationship management software 360, is used to manually obtain data from the website 305 over the Internet 315 via a modem 355. The user terminal may also run a customer relationship management software interface to allow the user to interact with and control the automatic ordering system.

The Agent Validation 370, Data Cross Referencing 390, and Chronological Determination 365 processes are completed by the database 385 on a scheduled basis that is determined by the user. These are processes that are performed on the data that was extracted from the website 305 and stored in the database 385.

The Agent Validation process 370 is performed on data that is collected from a MLS website 305 in order to identify the agent from each MLS property listing. This process uses information in the database 385 to match an agent in a property listing to a state licensed real estate agent.

The geocoding software 375 is used if the Agent Validation process is unable to correlate an agent from a property listing to a valid agent licensed by the state. An example of such geocoding software is MapMarker 6.0 by MapInfo. The geocoding software 375 uses map coordinates to determine the distance between an agent's address and a property address. As a result, the agents that are located closest to the property listing can be further examined in order to find the correct agent.

The Data Cross Referencing process 390 is performed to fill in any empty data in the REWebData table in the database 385. The REWebData table in the database 385 contains all of the property listing data captured by the Robots 350 via the Internet 315. This process is used to fill in empty data such as the zip code, county, state, office address, agent and office phone numbers, etc.

The Chronological Determination 365 process moves sold, or off-market, properties from the table to the SoldListings table.

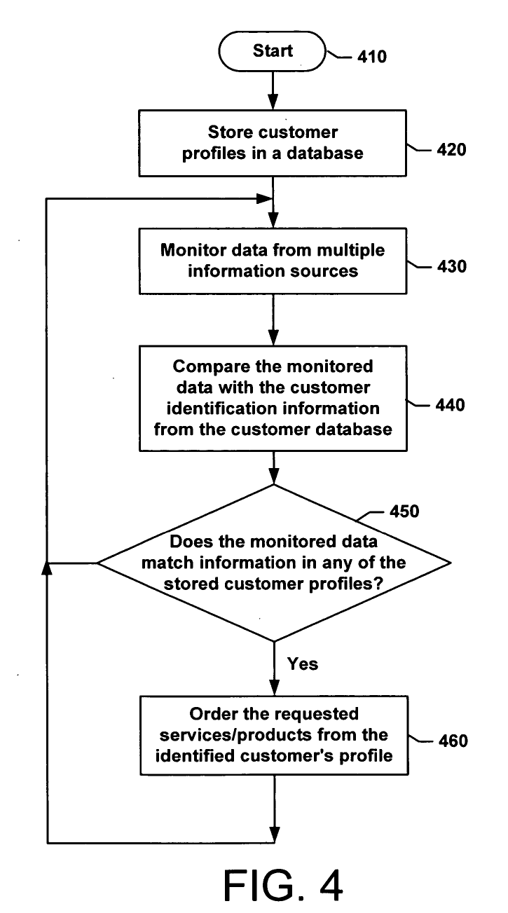

FIG. 4 illustrates in a flowchart one embodiment of an overview of the automatic order process. The database server 380 starts the process in Step 410 by storing customer profiles in a database 385 in Step 420. The database server 380 monitors data from multiple information sources in Step 430. In Step 440, the database server 380 compares the monitored data with the customer identification information from the customer database. As shown in Step 450, if the monitored data does not match information in any of the stored customer profiles, the database server 380 returns to monitoring data from multiple information sources in Step 430. If the monitored data matches information in any of the stored customer profiles, the requested services or products are ordered from the identified customer's profile in Step 460. The database server 380 returns to monitoring data from multiple information sources in Step 430.

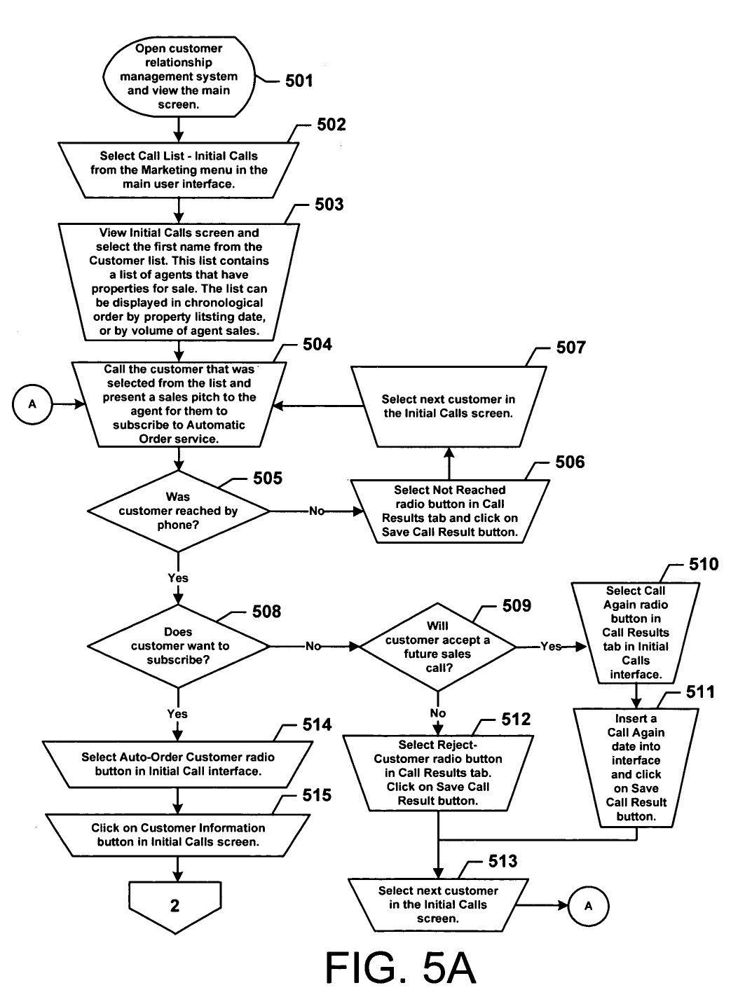

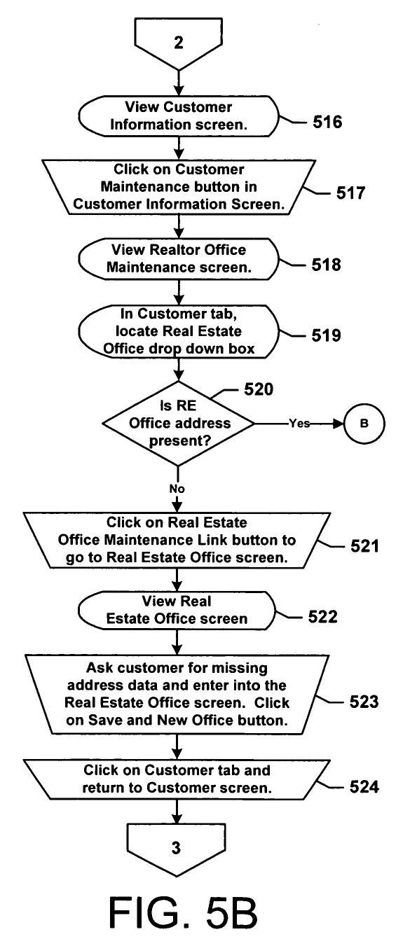

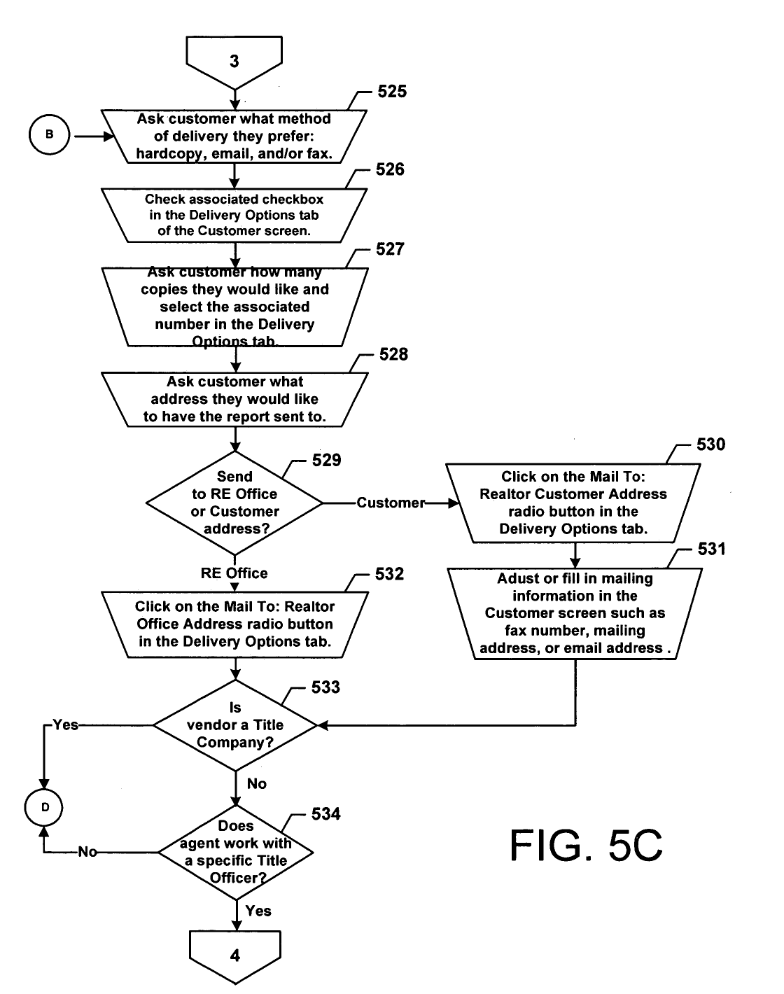

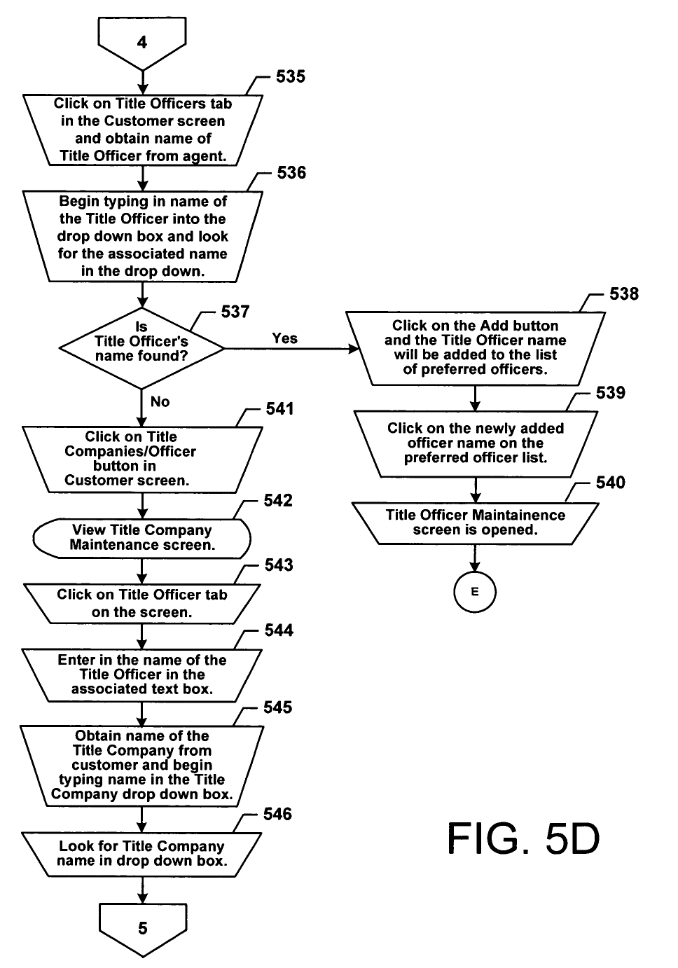

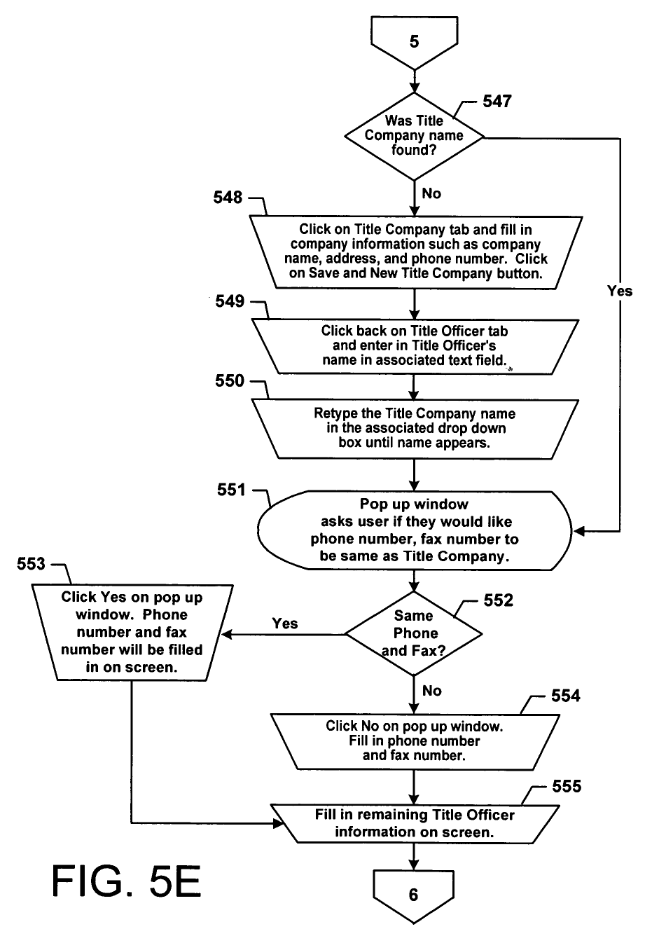

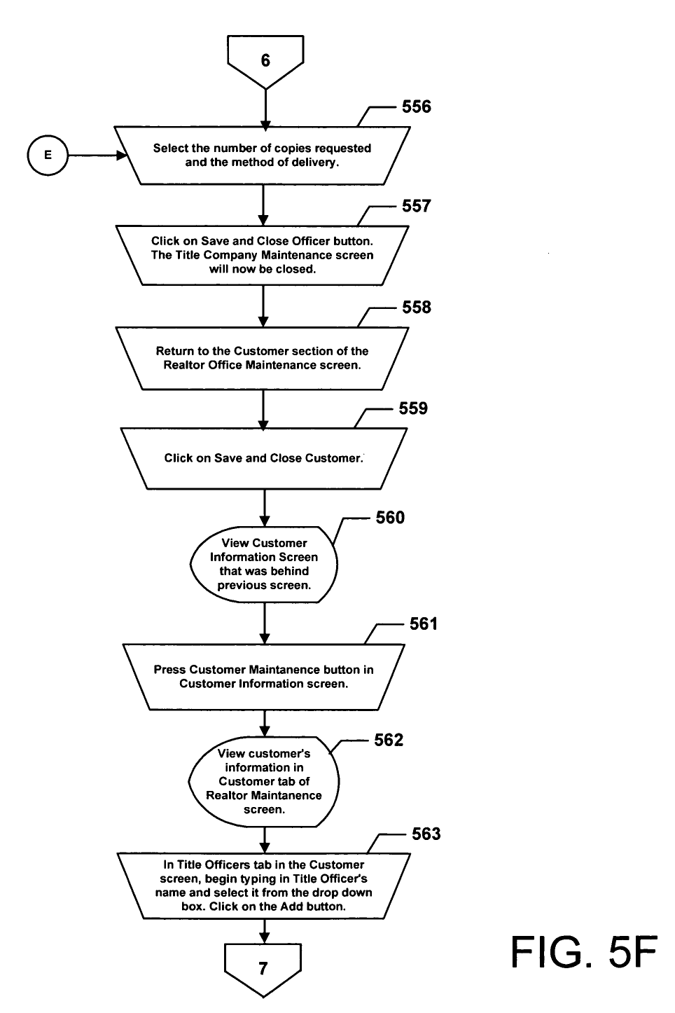

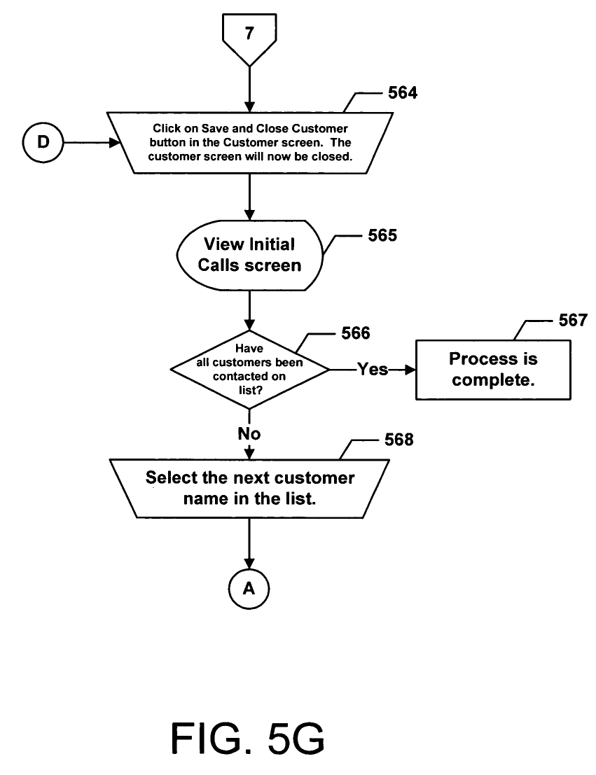

FIGS. 5A-5G is a diagram that depicts the Automatic Order process. This process includes having a list of potential customers with properties for sale on the market, presenting a sales pitch to the potential customer, and adding the new customer to the system with their individual order preferences.

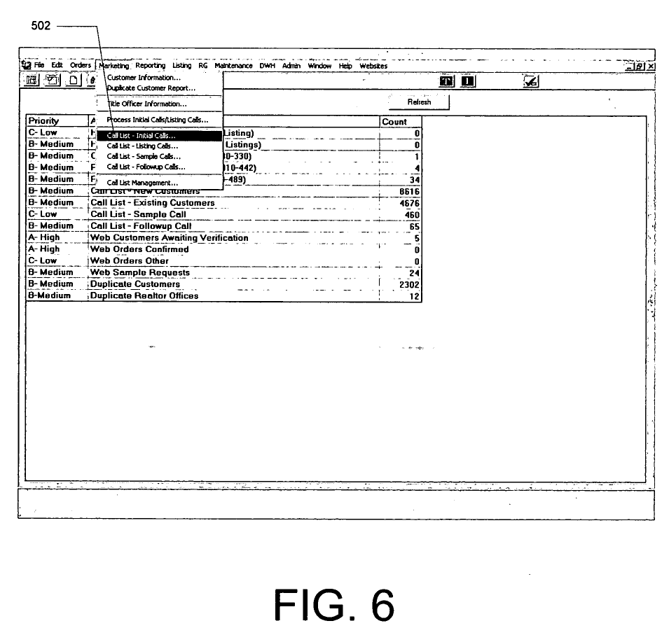

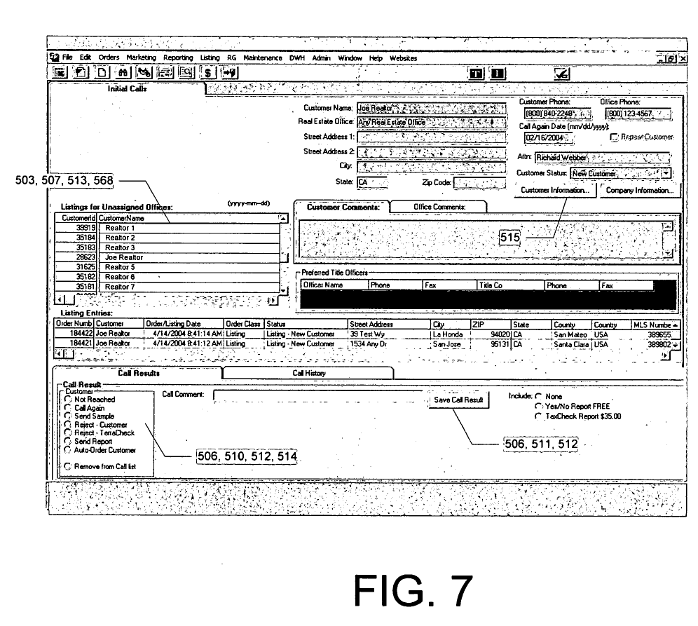

The process begins in Step 501, where the user opens the customer relationship management system and views the main user interface. In Step 502, the user selects Call List-Initial Calls from the Marketing menu in the main interface (FIG. 6). As a rule, the Initial Calls interface must display at minimum the realtor/agent's name, phone number, property listing address, property listing date, and current customer status. Optionally, the customer's office name, phone number, MLS number, and email address are displayed on the screen. The user then views the Initial Calls screen (FIG. 7) and selects the first name from the customer list in Step 503. This list contains a list of agents that have properties for sale. The list is displayed in chronological order—the agent with the most recent listings being displayed first. It can also be displayed by order of sales volume for each agent. In Step 504 (A), the user calls the potential customer that was selected on the list and determines if the realtor wants to participate in the Automatic Order System. Step 505 determines if the customer was reached by phone. If the customer was not reached then Step 506 is performed. In Step 506, the user selects the Not Reached radio button in the Call Results tab on the screen and then clicks on the Save Call Result button. Consequentially, the customer will still remain in the system so they can be contacted at a later date. In Step 507, the next customer is selected from the Initial Calls screen. The diagram then returns to Step 504, and the selected customer is contacted.

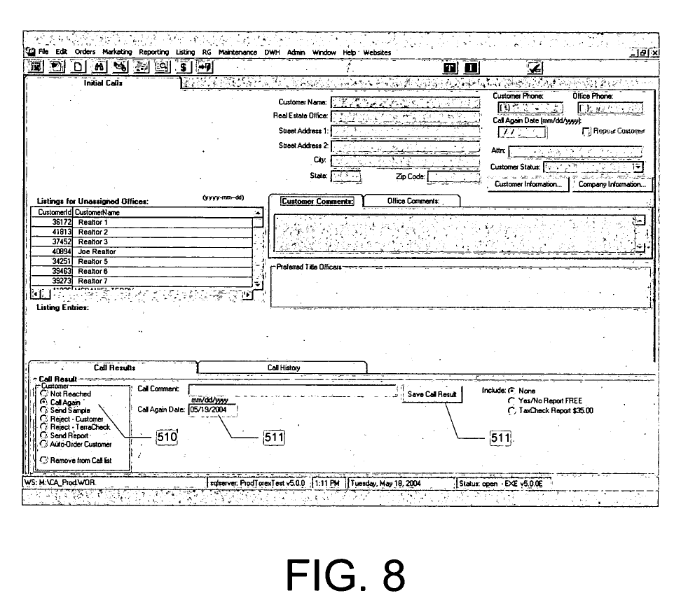

If the customer was reached in Step 505, the diagram continues to Step 508. Step 508 determines if the customer would like to participate in the Automatic Order System. If they would not like to subscribe at the current time, the diagram continues to Step 509. In this step, the user asks the customer if they will accept a future sales call. If the agent would not like a future sales call, the user selects the Reject-Customer radio button in the Call Results tab in Step 512. This results in this realtor being permanently removed from the call list. Then the next customer is selected from the list to call in Step 513. The diagram returns to Step 504 (A) and the next customer is contacted. If the customer will accept a future sales call in Step 509, the user selects the Call Again radio button in the Call Results tab in Step 510. When this button is selected, a text field will appear on the screen to enter in a Call Again date (FIG. 8). The user then enters in a future date to contact the customer and presses the Save Call Result button in Step 511. The diagram continues to Step 513, and the next customer is selected from the list. The diagram then returns to Step 504 (A).

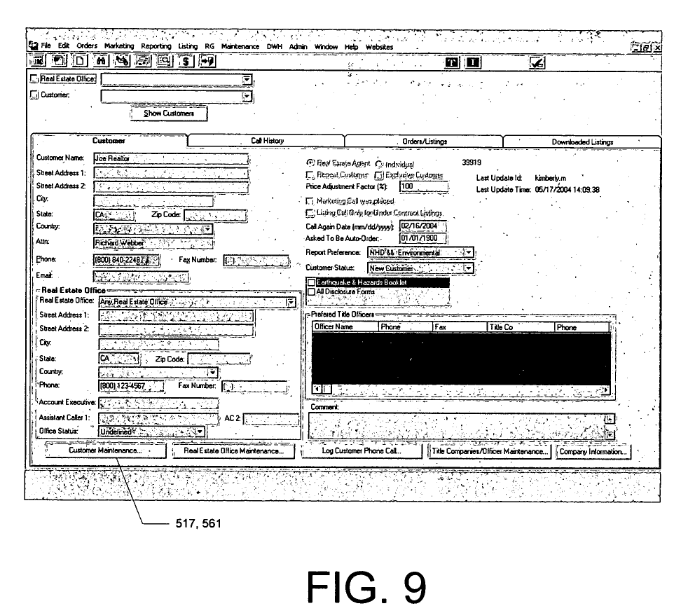

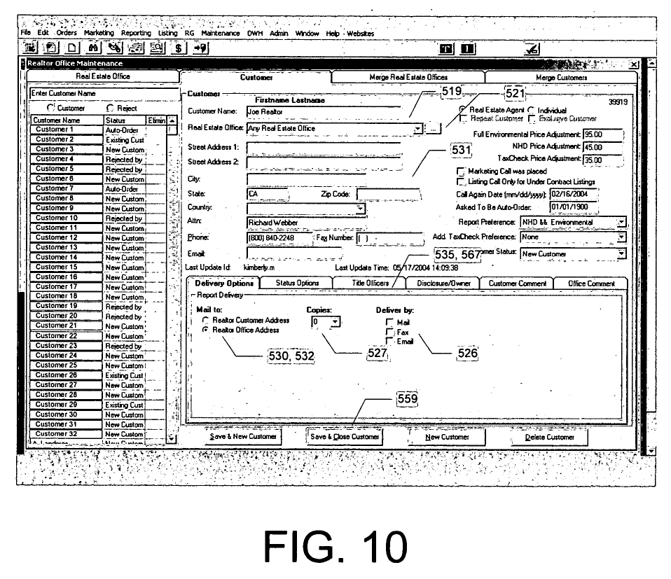

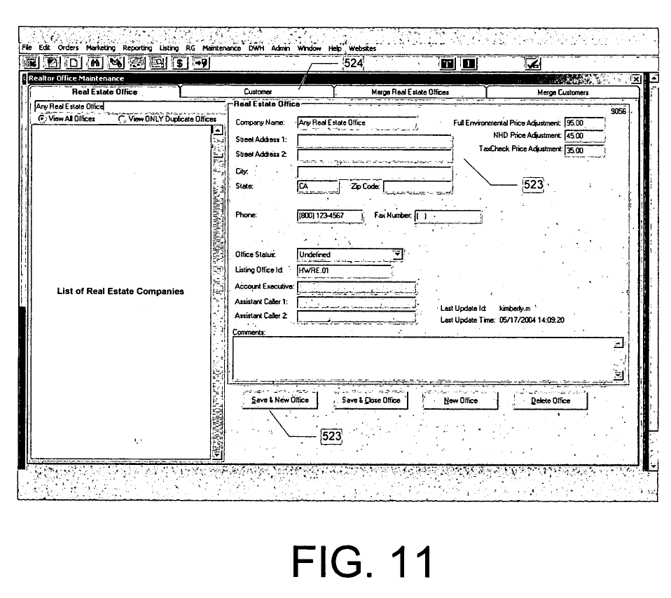

If the customer does want to subscribe to the Automatic Order service in Step 508, the user selects the Auto-Order Customer radio button in the Initial Calls interface in Step 514. In Step 515, the user clicks on the Customer Information button in the user interface. Upon pressing the button, the Customer Information screen (FIG. 9) appears for the user to view in Step 516. In Step 517, the user then clicks on the Customer Maintenance button on the screen. Upon pressing the button, the realtor Office Maintenance screen appears in Step 518. This interface will be used to record information about the customer. In the Customer tab of the realtor Office Maintenance screen (FIG. 10), the user locates the Real Estate Office drop down box in Step 519. Step 520 determines if the real estate office address is found in the drop down box next to the office name. If the address is found, the diagram continues to Step 525 (B). If the office address is not found, it needs to be added into the Real Estate Office screen (FIG. 11). In Step 521, the user clicks on the Real Estate Office Link button in the realtor Office Maintenance screen.

In Step 522, the Real Estate Office screen is viewed. In Step 523, the user asks the customer for any missing address information and enters it in into the Real Estate Office screen. This information includes the address, phone number, fax number, and email address of the real estate company. The user presses the Save and New Office button to implement the changes. In Step 524, the user clicks back on the Customer tab and returns to the Customer screen. The real estate office address will now be in the system so that the user can view it on the Customer screen. In Step 525 (B), the user asks the customer what method of delivery they would prefer for their report. The options for delivery are mail, email, or fax. In Step 526, the user checks the associated checkbox in the Delivery Options tab of the Customer screen. In Step 527, the user asks the customer how many copies of the report they would like and selects the associated number in the Delivery Options tab. In Step 528, the user then asks the customer what address they would like their report sent to.

Step 529 determines if the report is to be sent to the customer's real estate office address or to a separate Customer address. If the report will be sent to the Customer address, Step 530 is performed and the user clicks on the Mail To: realtor Customer Address radio button in the Delivery Options tab. In Step 531, the user fills in the customer's mailing information in the Customer screen such as the fax number, mailing address, or email address depending on the delivery option selected. The diagram then continues to Step 533. If the customer would like the report to be sent to their real estate office address in Step 529, the diagram continues to Step 532. In Step 532, the user clicks on the Mail To: realtor Office Address radio button in the Delivery Options tab.

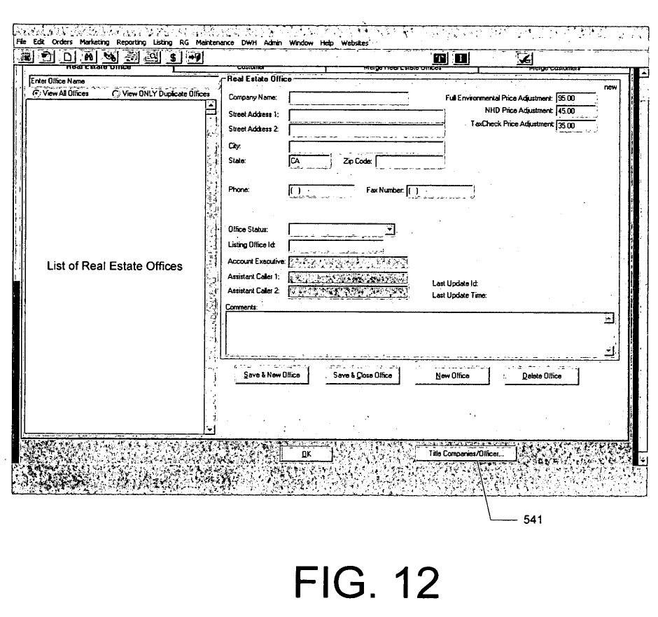

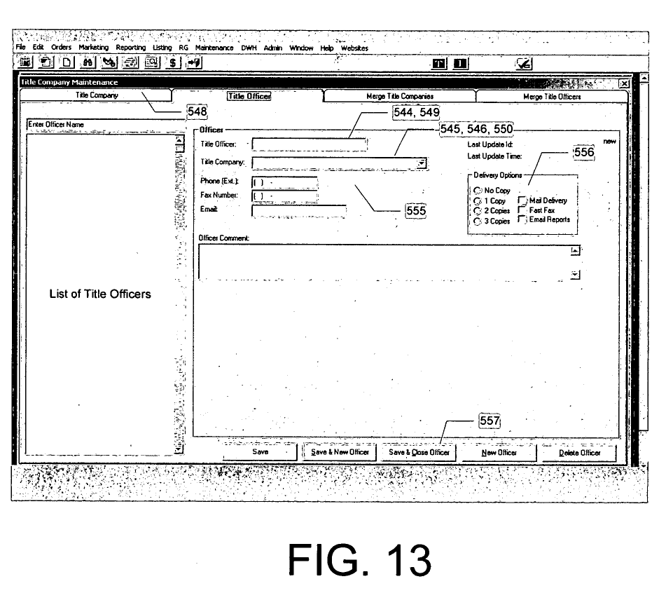

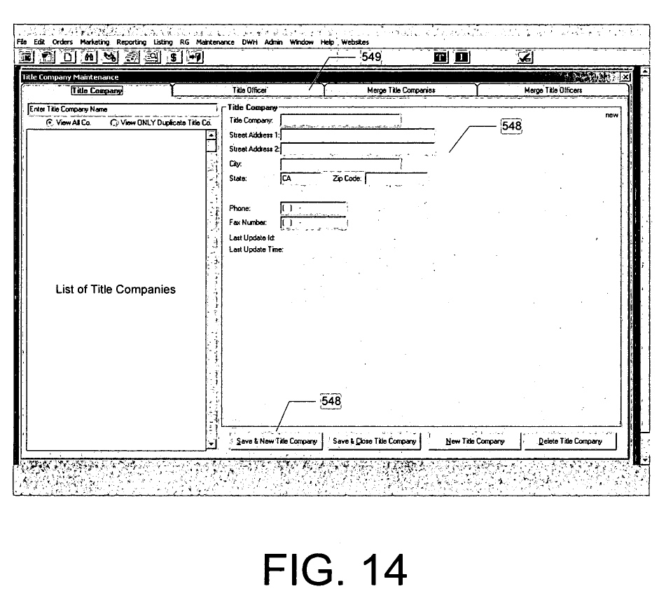

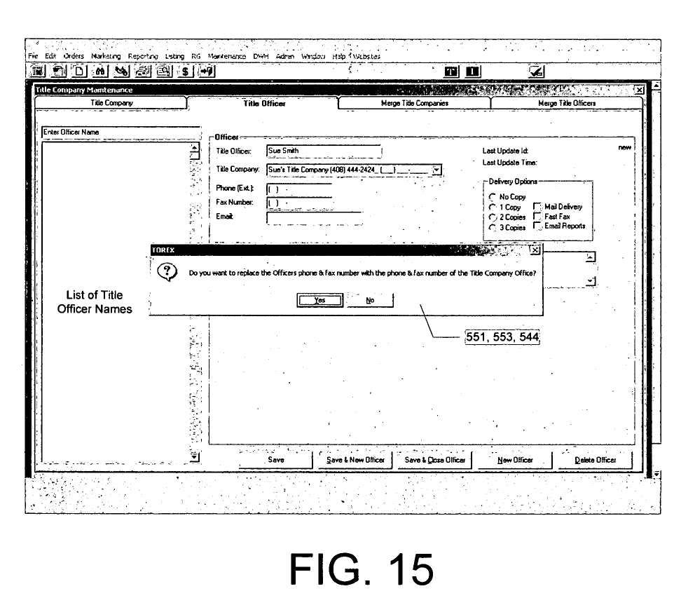

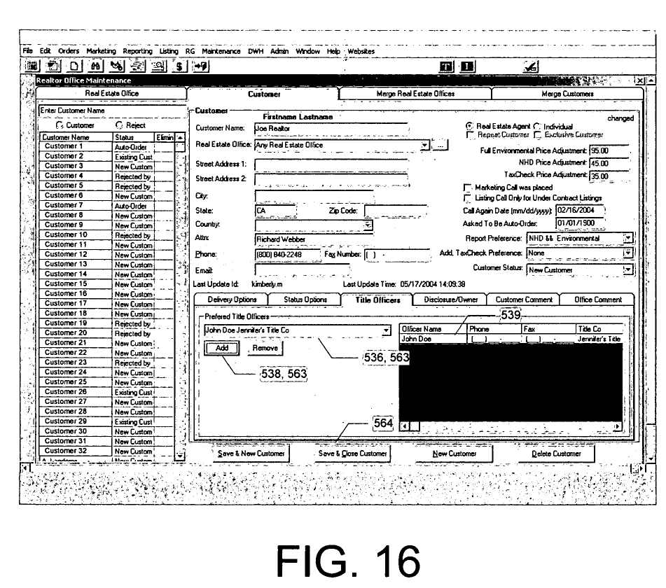

Step 533 determines if the vendor is a title company. If the vendor is a title company, the diagram skips to Step 564 (D). If the vendor is not a title company, Step 534 determines if the customer works with a specific title officer. If they do not, the diagram skips to Step 564 (D). If the customer does work with a specific title officer, the user will try to locate them in the database. In Step 535, the user clicks on the Title Officer tab in the Customer screen (FIG. 16) and obtains the name of the title officer from the customer. In Step 536, the user begins to type in the name of the title officer into the associated drop down box and looks for the name in the drop down. Step 537 determines if the name was found. If the title officer's name was found, then the user proceeds to Step 538, where the Add button is selected, and the title officer's name is added to the list of preferred officers for that customer. In Step 539, the user clicks on the newly added officer's name on the preferred officers list. As a result, the Title Officer Maintenance screen is opened in Step 540. The diagram then continues to Step 556 (E). If the name was not found in Step 537, the diagram continues to Step 541. The title officer will need to be added into the system. In Step 541, the user clicks on the Title Companies/Officer button (FIG. 12) in the Customer screen. In Step 542, the user views the Title Company Maintenance screen. In Step 543, the user clicks on the Title Officer tab on the screen in order to view the Title Officer screen (FIG. 13). In this screen, the user will add the new title officer into the system. In Step 544, the name of the title officer is entered into the associated text box. In Step 545, the user obtains the name of the title company from the customer and begins typing the name into the title company drop down box. In Step 546, the user looks for the title company name in the drop down. Step 547 determines if the title company name is found. If it is found, the diagram skips to Step 551. If the title company's name was not found in Step 547, the title company will need to be added into the system. In Step 548, the user clicks on the Title Company tab on the screen and views the Title Company screen (FIG. 14). Then the user creates a new record for the title company and fills in the company's information, such as the company name, address, and phone number. The Save and New Title Company button is then pressed, and the title company information saved. Now the user will need to try and add the title officer to the system again. In Step 549, the user clicks back on the Title Officer tab and enters in the title officer's name into the associated text field. In Step 550, the user retypes the title company name into the associated drop down box until the name appears. Upon entering in the name of the title company, a pop up window appears (FIG. 15) and asks the user if they would like the title officer's phone number and fax number to be the same as the title company's. This occurs in Step 551. Step 552 determines if the customer would like the phone and fax numbers to be the same. If they do, the diagram proceeds to Step 553 and the user clicks Yes on the pop up window. This causes the same phone and fax numbers to appear in the title officer's record on the screen. If the customer does not want the phone and fax numbers to be the same as their title company's in Step 552, the diagram continues to Step 554. In Step 554, the user clicks No on the pop up window and populates the phone and fax numbers fields in the screen with information given by the customer. In Step 555, the user fills in any remaining information for the title officer into the screen. In Step 556 (E), the user selects the number of copies of a report that the title officer would like to have and the method of delivery. In Step 557, the user clicks on the Save and Close Officer button to save the data and exit the Title Company Maintenance screen. Now that this screen is closed, the realtor Office Maintenance screen will appear in the window.

Step 558 returns the user to the Customer tab of the realtor Office Maintenance screen. In Step 559, the user clicks on the Save and Close Customer button and exits the screen. The user must close and re-enter the screen in order for the title officer information to refresh and become available in the Customer screen. In Step 560, the user views the Customer Information Screen that was covered from view by the previous screen. In Step 561, the user presses the Customer Maintenance button in the Customer Information screen. In Step 562, the customer's information is viewed again in the Customer tab of the realtor Office Maintenance screen. In Step 563, the user clicks on the Title Officers tab in the Customer screen and begins typing the title officer's name into the associated drop down box. Once the name has been found and selected, the user clicks on the Add button to add the title officer's information to the customer's record. In Step 564 (D), the user clicks on the Save and Close Customer button in the Customer screen. The customer's information has now been saved and the screen closes. In Step 565, the user views the Initial Calls screen, which was tiled behind the previous screen. In Step 566, the user determines if all of the customers have been contacted on the list. If this is true, the process of contacting customers for the Automatic Order service is complete in Step 567. If customers remain in the Initial Calls screen, the user selects the next customer name on the list in Step 568 and returns to Step 504 (A) in the diagram.

FIG. 6 is a screen shot of the main user interface in the customer relationship management software. In the interface, the user selects the Call List-Initial Calls menu item from the Marketing menu (502). This will allow the user to access the Initial Calls screen, which contains a list of potential customers along with their property listing information.

FIG. 7 is a screen shot of the Initial Calls screen. In this screen, a list of agents is displayed that have properties currently for sale on the market. The list is displayed in chronological order, with the agent with the most recent listings being displayed first. This list can also be displayed by the volume of sales for each agent. The list will be used to make sales calls and secure future Automatic Order customers (503, 507, 513, 568). Due to the fact that these agents have current listings, they will be in need of services such as home inspections, natural hazard reports, home loan quotes, etc. For each agent on the list, the screen displays information such as the property listing date, property address, and current customer status. The screen also has a tab to record the user's call results for an agent. In this section, the user can record the results of their sales call by clicking on the associated radio button to record their results (506, 510, 512, 514). The user can then provide any comments and save the call results using the Save Call Result button (506, 511, 512). The screen also contains a button that will take the user to the Customer Information Screen (515).

FIG. 8 is a screen shot of the Call Again Date field (511) in the Initial Calls screen that appears when the Call Again radio button is selected. This feature will provide a reminder to the user to make another sales call to the agent on a date specified by the user. The user can create a call again date, write comments, and save the call result by pressing the Save Call Result button (511).

FIG. 9 is a screen shot of the Customer Information screen. This screen displays the customer's data and contains a button that can be pressed (517, 561) to navigate to the Customer tab of the realtor Office Maintenance Screen.

FIG. 10 is a screen shot of the Customer tab in the realtor Office Maintenance Screen. This screen displays customer data such as the customer's name, office name, address, phone number, fax number, and/or email address. A customer's information can be pulled up onto the screen by typing in the name of a customer in the top left text box and then selecting the name from the scroll down list. If a customer has been selected already from the Initial Calls screen, their data will automatically appear on the screen when it is opened. Once a customer's information is displayed, it may be modified, updated, or deleted and then saved into the system (531, 559). The office name can be selected from a pull down box that contains a list of real estate offices in the system (519). The customer screen also contains a Delivery Options tab that can be selected in order to fill in delivery information for a customer. The user can select the address that the report will be sent to (530, 532), the number of copies to be sent (527), and the method in which the report will be sent: mail, fax, or email (526). The screen also has a tab that contains information on the customer's title officers (535, 567). There is another tab that can be selected in order to proceed to the Real Estate Office screen. By using this tab, the user can navigate between the Customer and Real Estate Office screens. A user can also navigate to the Real Estate Office screen with the customer's data present by clicking on the Real Estate Office Maintenance Link button (521).

FIG. 11 is a screen shot of the Real Estate Office tab of the realtor Office Maintenance screen. This particular screen displays information about the real estate company. It includes fields such as the real estate office's name, address, phone number, and fax number (523). It also includes the office's current status as a customer and a section to enter comments into the screen. On the left hand side of the screen, the user can search for a real estate office by typing in the name and selecting it from the list of offices. When the office name is selected, the associated data is pulled up onto the screen. Then, the user may add, modify, or delete the real estate office data on the screen. The user can navigate back to the Customer screen by clicking on the Customer tab (524).

FIG. 12 is a screen shot of the Title Companies/Officer button in the realtor Office Maintenance screen which is pressed to navigate to the Title Company Maintenance screen.

FIG. 13 is a screen shot of the Title Officer tab of the Title Company Maintenance screen. In this screen, a user may add a new title officer into the system that correlates with an existing title company. The user can look up a title officer by typing the name into a text box in the upper left hand side of the screen and selecting the officer's name from the corresponding selection box. Upon being selected, the title officer's name and information will appear on the screen (555). The user can modify, add, or delete information from the screen and save the results in the system (557). Also, a user can add a new title officer by typing in the title officer's name (544, 549) and searching for the name of their title company in the associated drop down box (545, 546, 550). The user can then add the remaining information into the screen and save the results. If the title company name cannot be found, it must be added into the system by clicking on the Title Company tab and adding a new record (548). The user may also add any order preferences for the title officer such as the number of copies requested and the method of delivery into the screen (556).

FIG. 14 is a screen shot of the Title Company tab in the Title Company Maintenance screen. In the Title Company tab, the user can add and update title company records in the system. A user can enter in a new title company into the system by adding the company name, address, phone number, and/or fax number and clicking on the Save and New Title Company button (548). The user may locate a title company that is already in the system by typing the title company's name into a text box on the upper left hand of the screen. Upon typing in the title company name, the user can locate the name in the scroll down box below. Once the title company name is selected, the title company's data will appear in the text fields on the screen. The user may modify, update, or delete the information on the screen and save it into the system. The user also has the ability to delete a title company from the system in this screen. The Title Officer screen can be accessed from the screen by clicking on the Title Officer tab (549).

FIG. 15 is a screen shot of a Title Officer screen pop up message. This is a message that occurs when a user is adding a new title officer into the screen and the title company name is entered. A pop up message will appear to the user and ask them if they would like the title officer to have the same phone and fax numbers as the title company. If the user clicks Yes, the associated fields will automatically be populated with the fax and phone numbers of the title company. If the user clicks No, there will be no changes to the screen.

FIG. 16 is a screen shot of the Title Officers tab within the Customer screen. In this tab, the user can search for a particular title officer in the system and add them to a customer's preferences. The title officer's name can be found by typing the name into a drop down box (536, 563) and selecting the name from a drop down menu. The name can then be added into the system by clicking on the Add button (538, 563) and then saving the customer's data (564). A title officer can be deleted from the customer's preferences by pressing the Delete button.

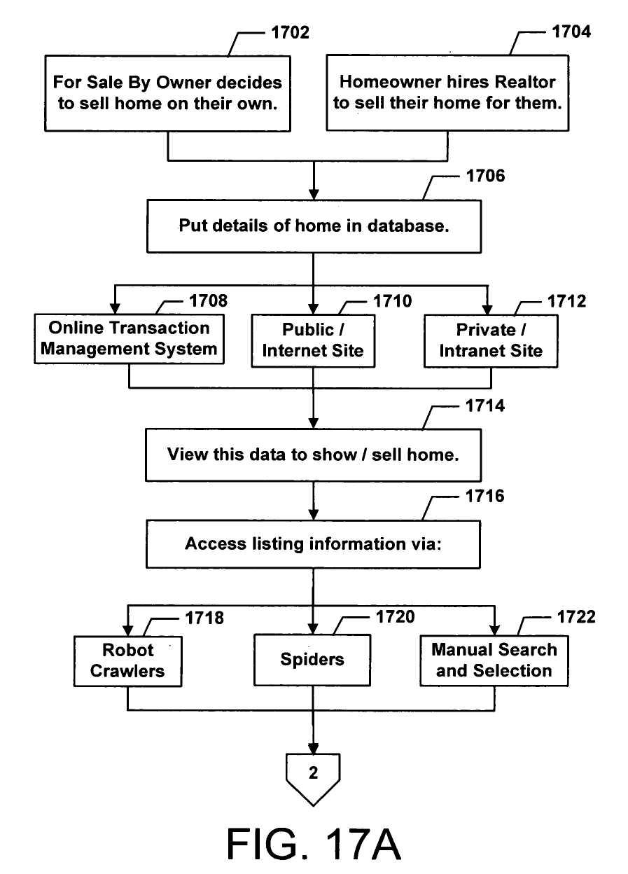

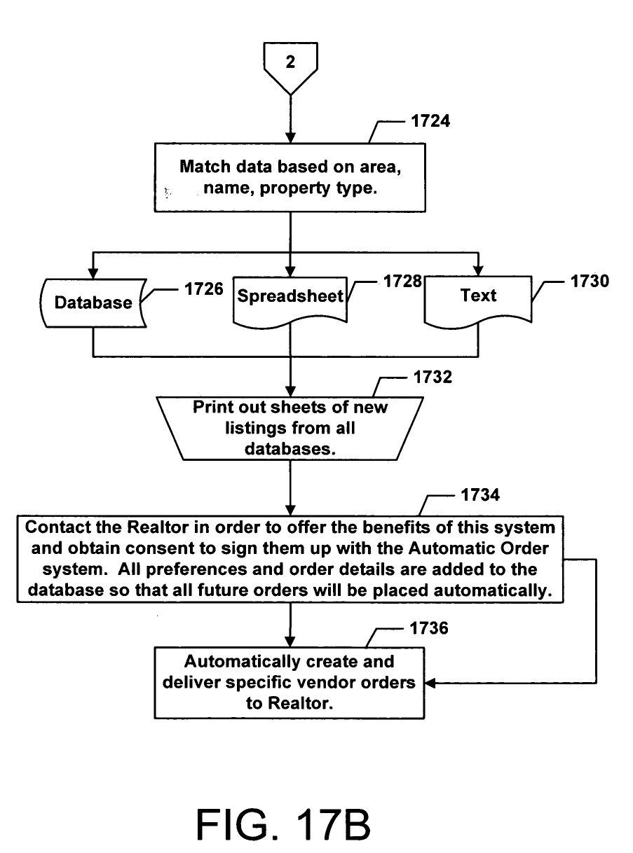

FIGS. 17A-B describes different ways in which this invention may be executed. The first section identifies variations in origination. The listing cycle may be initiated either by a homeowner choosing to market the home by themselves (Step 1702) or a homeowner hiring a realtor to market the home (Step 1704). In either case, the details of the home for sale (listing) will be placed into a database (Step 1706). The database may take any one or more forms, such as an online transaction management system (Step 1708), a public site or the internet (Step 1710), or a private site or intranet (Step 1712). The listing information then becomes available for viewing (Step 1714) and access (Step 1716). The information may then be accessed and extracted by a number of methods, including robot crawlers (Step 1718), spiders (Step 1720), and manual search and selection (Step 1722). Data matches may be made based on area, name, or property type (Step 1724). Once the extraction is complete, the vendor may then receive a variety of output formats, such as electronic database (Step 1726), spreadsheets (Step 1728), or text (Step 1730). The vendor may then print out sheets of new listings from all of the databases (Step 1732). With the output in hand, the vendor can then proceed to establishing contact with the target to set them up on the automatic order system (Step 1734). Once the automatic order trigger is in place, the vendor can send their services to their targeted customers automatically (Step 1736).

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. A computer implemented method for processing event-triggered transactions, comprising:
storing customer profiles in a database, the customer profiles including customer identification information and at least one or more customer-requested services and products that are to be automatically ordered upon the occurrence of specific events;
monitoring data from multiple information sources for event trigger transactions; and
comparing the monitored data with the customer identification information from the customer database such that if the monitored data matches the customer identification information, automatically ordering the one or more services and products specified in the profile of the identified customer.

2. The method of claim 1, wherein the specific events, information sources, services, and products are all real estate related.

3. The method of claim 2, wherein the customer profiles comprise a list of real estate agents along with their contact and property listing information.

4. The method of claim 3, wherein the customer profiles comprise a preferred title officers.

5. The method of claim 1 further comprising displaying the customer profiles to a user.

6. The method of claim 5 further comprising:
allowing a user to select a customer profile; and
contacting a customer associated with the customer profile to sign them up to receive the service on an automatic and continual basis.

7. The method of claim 6, further comprising:
determining whether the customer wants to subscribe to automatic ordering;
removing the customer profile from the database if the customer does not want to subscribe;
marking the customer profile to be called back at a later time if the customer wants; and
using a customer relationship management software interface to record information about a new automatic order system customer's office, home, and order preferences if the customer wants to subscribe.

8. The method of claim 1 wherein the customer associated with a customer profile receives the product or service on an automatic and continual basis when the event-triggering transactions occur.

9. An automatic order system comprising:
a communication port that allows monitoring of data from multiple information sources for event trigger transactions;
a database containing a plurality of customer profiles;
a database server connected to the database for operating on said database;
a customer relationship management software program that compares the monitored data with the customer identification information from the customer database such that if the monitored data matches the customer identification information, automatically ordering the one or more services and products specified in the profile of the identified customer;
a database connectivity engine connected to said customer relationship management software program and said database server.

10. The automatic order system of claim 9, wherein the specific events, information sources, services, and products are all real estate related.

11. The automatic order system of claim 10, wherein the customer profiles comprise a list of real estate agents along with their contact and property listing information.

12. The automatic order system of claim 11, wherein the customer profiles comprise a preferred title officers.

13. The automatic order system of claim 9, further comprising a user interface that displays the customer profiles to a user.

14. The automatic order system of claim 13, wherein the user interface allows a user to select a customer profile, causing a customer associated with the customer profile to be contacted to sign them up to receive the service on an automatic and continual basis.

15. The automatic order system of claim 14, wherein, upon determining whether the customer wants to subscribe to automatic ordering, the customer profile is removed from the database if the customer does not want to subscribe, the customer profile is marked to be called back at a later time if the customer wants, and the customer relationship management software records information about a new automatic order system customer's office, home, and order preferences if the customer wants to subscribe.

16. The automatic order system of claim 9, wherein the customer associated with a customer profile receives the product or service on an automatic and continual basis when the event-triggering transactions occur.

17. An automatic order system comprising:
a means for storing customer profiles in a database, the customer profiles including customer identification information and at least one or more customer-requested services and products that are to be automatically ordered upon the occurrence of specific events;
a means for monitoring data from multiple information sources for event trigger transactions; and
a means for comparing the monitored data with the customer identification information from the customer database such that if the monitored data matches the customer identification information, automatically ordering the one or more services and products specified in the profile of the identified customer.

18. The automatic order system of claim 17, wherein the specific events, information sources, services, and products are all real estate related.

19. The automatic order system of claim 18, wherein the customer profiles comprise a list of real estate agents along with their contact and property listing information.

20. The automatic order system of claim 17, wherein the customer associated with a customer profile receives the product or service on an automatic and continual basis when the event-triggering transactions occur.
